(19) United States
(12) Patent Application Publication
(10) Pub. No.: US 2007/0214479 A1
(43) Pub. Date: Sep. 13, 2007

(54) Digital broadcasting system and method for broadcasting service provider data

(75) Inventor: Jong-Hyuk Choi, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/705,817

(22) Filed: Feb. 13, 2007

(30) Foreign Application Priority Data
Feb. 15, 2006 (KR) 2006-14854

(51) Int. Cl. H04N 5/445; G06F 13/00; H04N 7/173

(52) U.S. Cl. 725/39; 725/54; 725/44; 725/131

(57) ABSTRACT

Provided is a digital broadcasting system and method for broadcasting service provider data. The system includes a broadcasting station for inserting the service provider data, generated by a service provider that provides digital broadcasting contents to users, into program guide information, and broadcasting the service provider data, together with multimedia data based on the various digital broadcasting contents; and a digital broadcasting receiving terminal for receiving, decoding and output the multimedia data, and receiving the program guide information including the service provider data from the broadcasting station, extracting the service provider data, and output the extracted service provider data according to preset output setting.

### PRIORITY

This application claims priority under 35 U.S.C. § 119 to an application entitled “Digital Broadcasting System and Method for Broadcasting Service Provider Data” filed in the Korean Intellectual Property Office on Feb. 15, 2006 and assigned Serial No. 2006-14854, the contents of which are incorporated herein by reference.

### BACKGROUND OF THE INVENTION

1. Field of the Invention

The present invention relates generally to a digital broadcasting system, and in particular, to a system and method for inserting service provider data into digital broadcasting data.

2. Description of the Related Art

In general, digital broadcasting, which replaces conventional analog broadcasting, refers to a broadcasting service of providing a high definition, high fidelity, and high quality digital broadcast service to a user. Digital broadcasting varies in kind. Digital broadcasting can include, in its category, digital multimedia broadcasting (DMB), digital audio broadcasting (DAB), digital video broadcasting (DVB), MediaFLO, and digital video broadcasting-handled (DVB-H) as a kind of digital broadcasting.

However, in the case of digital broadcasting, various advertisements or information can be inserted into broadcasting contents to users. Such advertisements or information are generated and provided by a contents provider or a broadcast service provider.

FIG. 1 is a block diagram showing a typical construction of a DVB-H system among conventional digital broadcasting systems.

Referring to FIG. 1, a broadcasting station 100, which broadcasts digital data, can include contents providing unit 102 and a broadcasting unit 104. The contents providing unit 102, a constituent element taken charge of by a contents provider, generates a variety of digital broadcasting contents broadcasted by the DVB-H broadcasting station 100. The broadcasting unit 104, a constituent element managed by a service provider, packetizes and multiplexes the broadcasting contents generated by the contents providing unit 102, and broadcasts the broadcasting contents via a radio frequency (RF) signal. The contents provider refers to a provider who takes charge of generating the various broadcasting contents in digital broadcasting. The service provider refers to a provider who takes charge of broadcasting contents to the users, using a specific leased line communication frequency.

Data provided from the contents providing unit 102 can be classified as audio/video (AV) data, and electronic service guide (ESG) data. The AV data refers to multimedia data for allowing a receiver's terminal to reproduce the broadcasting contents provided from contents providing unit 102, as an audio signal and a video signal. The ESG data, guide information on the various broadcasting contents provided from contents providing unit 102, refers to data for allowing the user to search for his/her desired broadcasting contents. Receiving those data from the contents providing unit 102, the service provider packetizes and multiplexes the received data using broadcasting unit 104 in a digital broadcasting method and then, broadcasts the multiplexed data. Accordingly, broadcasting unit 104 includes a constituent element for packetizing the broadcasting data, and a multiplexer 110.

In case where the digital broadcasting system is a DVB-H system as shown in FIG. 1, the broadcasting unit 104 includes an Internet protocol (IP) capsulator 108 that is a packetizer. IP capsulator 108 refers to a constituent element for performing IP capsulation, that is, packetizing the AV data and the ESG data depending on an Internet protocol data casting (IPDC) method that is a DVB-H system broadcasting method. In addition to this, broadcasting unit 104 can also enhance the integrity of transmission data, using a transfer server 106 employing a flute protocol for more safely transmitting data, such as the ESG data.

If broadcasting station 100 broadcasts the multiplexed AV data and ESG data, a user's digital broadcasting receiving terminal 150 receives the data using a broadcasting receiver 152. Digital broadcasting receiving terminal 150 demultiplexes and decapsulates reception data, using demultiplexer 1154 and IP decapsulator 156 included in broadcasting receiver 152, to restore the data to original AV data and ESG data. Digital broadcasting receiving terminal 150 outputs the AV data to its multimedia processor 158 which outputs a digital broadcast depending on a channel selected by the user. Receiving terminal 150 also outputs the ESG data to its ESG storage unit 160. Based on user's request, ESG storage unit 160 outputs program guide information of the digital broadcasting contents broadcasted by broadcasting station 100.

As shown in FIG. 1, in the conventional digital broadcasting system, broadcasting unit 104 can merely packetize and broadcast the data received from contents providing unit 102 in a corresponding digital broadcasting method. Owing to this, the contents provider can insert broadcast service provider information, such as advertisements or information to be transmitted to the users, between the broadcasting contents, and transmit the broadcast service provider information to the users. However, though there is the information to be transmitted to the users, the service provider that broadcasts the broadcasting contents cannot transmit the information as long as the information is inserted into the broadcasting contents generated by the contents provider.

### SUMMARY OF THE INVENTION

It is, therefore, an object of the present invention to provide a digital broadcasting system and method for enabling a service provider to broadcast information that the service provider intends to transmit to users.

It is another object of the present invention to provide a digital broadcasting system and method for enabling a service provider to broadcast, information that the service provider intends to transmit to users even not going through a contents provider.

To achieve the above and other objects, there is provided a digital broadcasting system for broadcasting service provider data. The system includes a broadcasting station for inserting the service provider data. The data which is generated by a service provider providing a service of digital broadcasting contents to users using a specific leased line communication frequency, is inserted into program guide information of various digital broadcasting contents. The broadcasting station broadcasts the service provider data, together with multimedia data based on the various digital broadcasting contents; and a digital broadcasting receiving terminal for receiving the multimedia data from the broadcasting station. The digital broadcasting receiving terminal decodes and outputs the received multimedia data, and receives the program guide information comprising the service provider data from the broadcasting station, extracts the service provider data, and outputs the extracted service provider data depending on preset output setting.

In another aspect of the present invention, there is provided a method for broadcasting service provider data by a broadcasting station in a digital broadcasting system configured such that the broadcasting station broadcasts various digital broadcasting contents with the service provider data and a digital broadcasting receiving terminal for receiving the digital broadcasting contents and the service provider data. The method includes generating the service provider data in the broadcasting station; inserting the service provider data into program guide information of the broadcasting contents that are provided from a contents providing unit; packetizing the program guide information comprising the service provider data, and multimedia data based on the various broadcasting contents; multiplexing and broadcasting the packetized packet data; in the digital broadcasting receiving terminal, receiving and demultiplexing the multiplexed packet data; in the digital broadcasting receiving terminal, extracting the service provider data from the packet data associated with the program guide information, among the demultiplexed packet data; in the digital broadcasting receiving terminal, restoring the extracted service provider data, the multimedia data, and the program guide information, to original data; and in the digital broadcasting receiving terminal, outputting the service provider data depending on preset output setting.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a typical construction of a conventional digital video broadcasting system;

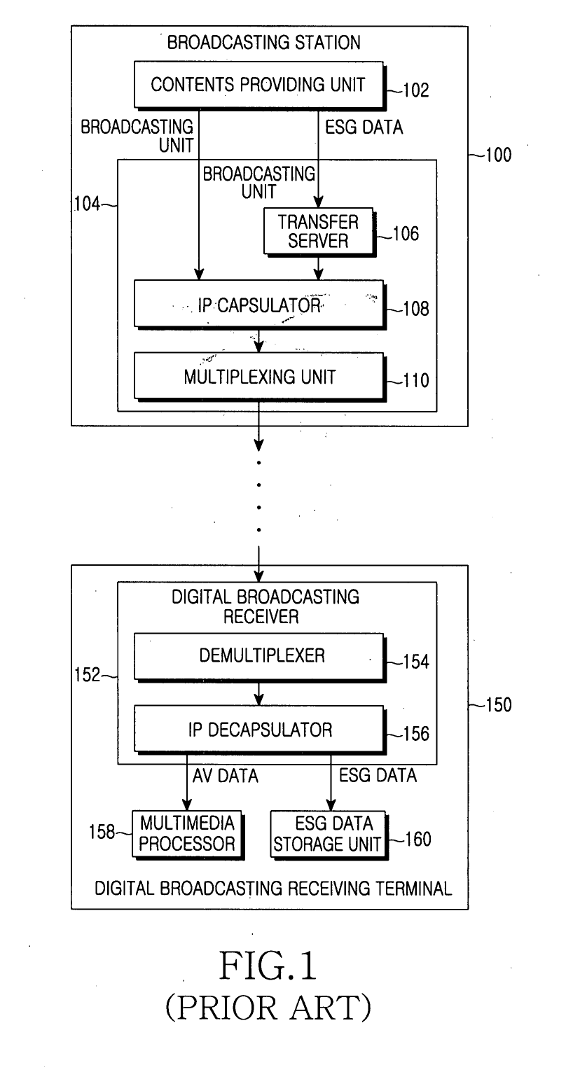

FIG. 2 is a block diagram illustrating a construction of a digital broadcasting station in a digital video broadcasting system according to the present invention;

FIG. 3 is a block diagram illustrating a construction of a digital broadcasting receiving terminal in a digital video broadcasting system according to the present invention;

FIG. 4 is a flowchart illustrating a process of broadcasting service provider data in a digital broadcasting station of a digital broadcasting system according to the present invention;

FIG. 5 illustrates an example of service provider data inserted by a digital broadcasting station according to the present invention;

FIG. 6 is a flowchart illustrating a process of packetizing broadcasted data in case where a digital broadcasting system uses a separate packet ID as identification information of service provider data according to the present invention;

FIG. 7 is a flowchart illustrating a process of extracting service provider data from received packet data in a digital broadcasting receiving terminal according to the present invention; and

FIG. 8 is a flowchart illustrating a detailed process of extracting service provider data from ESG data in a digital broadcasting receiving terminal according to the present invention.

### DETAILED DESCRIPTION OF THE PREFERRED EMBODIMENT

A preferred embodiment of the present invention will now be described in detail with reference to the annexed drawings. In the drawings, the same or similar elements are denoted by the same reference numerals even though they are depicted in different drawings. Detailed description of known functions and configurations incorporated herein has been omitted for conciseness.

In the present invention, in the case where a broadcasting unit receives broadcasting data from a contents providing unit, a service provider incorporates data to be provided to users into specific data of the received broadcasting data, and packetizes and broadcasts the data. To accomplish this objective in the present invention, the broadcasting unit inserts its own data into electronic service guide (ESG) data received from the contents providing unit, and packetizes the inserted data together with the ESG data, and broadcasts the packetized data over a channel for transmitting the ESG data. Thus, at a user side, the service provider data is extracted from the ESG data, using a packet ID depending on the service provider data. The extracted service provider data is output at the time of buffering the digital broadcasting or, in some cases, is output using a screen such as a pop-up window, during the digital broadcasting. Accordingly, the service provider as well as the contents provider can transmit the intended data that to the users.

In the interest of simplification, a DVB-H (digital video broadcasting-handled) system, one of the digital broadcasting systems, will be exemplified below.

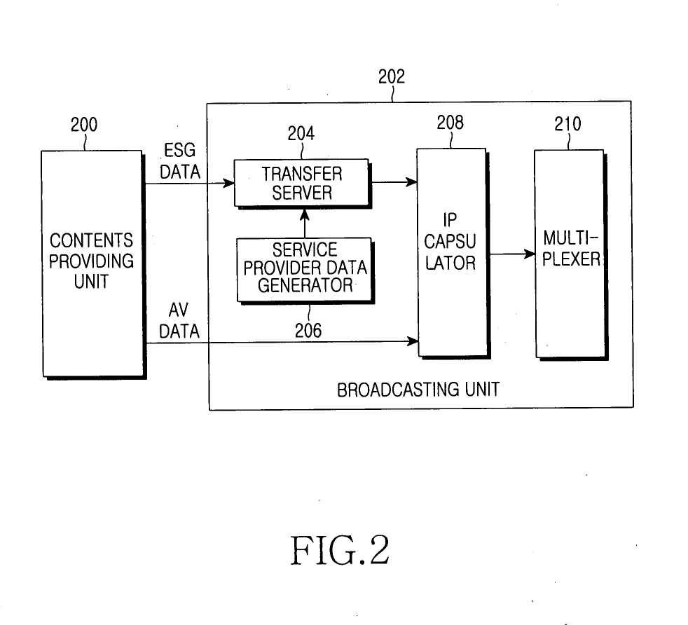

Referring to FIG. 2, the broadcasting unit, which broadcasts digital broadcasting data in a DVB-H method according to the present invention, includes the contents providing unit 200, and broadcasting unit 202 having a transfer server 204, a service provider data generator 206, an IP capsulator 208, and a demultiplexer 210.

Contents providing unit 200 provides broadcasting unit 202 with the digital broadcasting data generated by the contents provider as above, that is, audio/video (AV) data based on various broadcasting contents and the ESG data having additional information on the broadcasting contents.

Broadcasting unit 202 includes service provider data generator 206 for generating the service provider data, which is the broadcasting data that the service provider intends to provide to the users. Service provider data generator 206 generates the service provider data under the control of the service provider.

According to the present invention, broadcasting unit 202 includes transfer server 204 for, upon the transmission of data needing integrity such as the ESG data, performing a data integrity process of enhancing the data needing the integrity in using a protocol enhancing the data integrity. Transfer server 204 can be also a flute server using a flute protocol for transmitting data into which an error check bit is inserted. Being the flute server, transfer server 204 performs the data integrity process of inserting a spare bit, such as the error check bit, into the ESG data received from contents providing unit 200.

In the digital broadcasting system according to the present invention, transfer server 204 receives the service provider data from service provider data generator 206. Transfer server 204 inserts the received service provider data into the ESG data that is received from contents providing unit 200, and outputs the inserted data to IP capsulator 208. Thus, IP capsulator 208 of the digital broadcasting system capsulates, or packetizes the ESG data including the service provider data, together with the AV data received from contents providing unit 200. Demultiplexer 210 demultiplexes and broadcasts the packetized data.

Thus, the digital broadcasting receiving terminal receives the packetized data, and decodes the received data to an original signal through demultiplexing and decapsulating processes. The digital broadcasting receiving terminal extracts the service provider data from the ESG data, and separately stores the extracted service provider data.

There can be many ways of extracting the service provider data from the ESG data by the inventive digital broadcasting receiving terminal. For example, the digital broadcasting receiving terminal can extract the service provider data from the ESG data using the packet ID, or the digital broadcasting receiving terminal can also extract the service provider data from the received ESG data, using proper information for extracting the service provider data.

In the former case, in the digital broadcasting station, IP capsulator 208 of broadcasting unit 202 provides a packet ID different from that of the ESG data, to the service provider data. The packet ID provided to the service provider data can be included in a packet ID range of the channel for transmitting the ESG data. Accordingly, in transmission, the service provider data is transmitted over the channel for transmitting the ESG data, but, upon its receipt, can be classified by the extraction using the packet ID.

In the latter case, transfer server 204 can insert a bit value for indicating the service provider data, into the service provider data. In other words, transfer server 204 performs the data integrity process of adding the error check bit for the data integrity to the ESG data as described above. In this case, when receiving the service provider data, transfer server 204 can include bits predefined with the digital broadcasting receiving terminal instead of the error check bit, in order to indicate the service provider data. Thus, the digital broadcasting receiving terminal can check the error check bit region of the received ESG data, and check if the currently received ESG data is the service provider data.

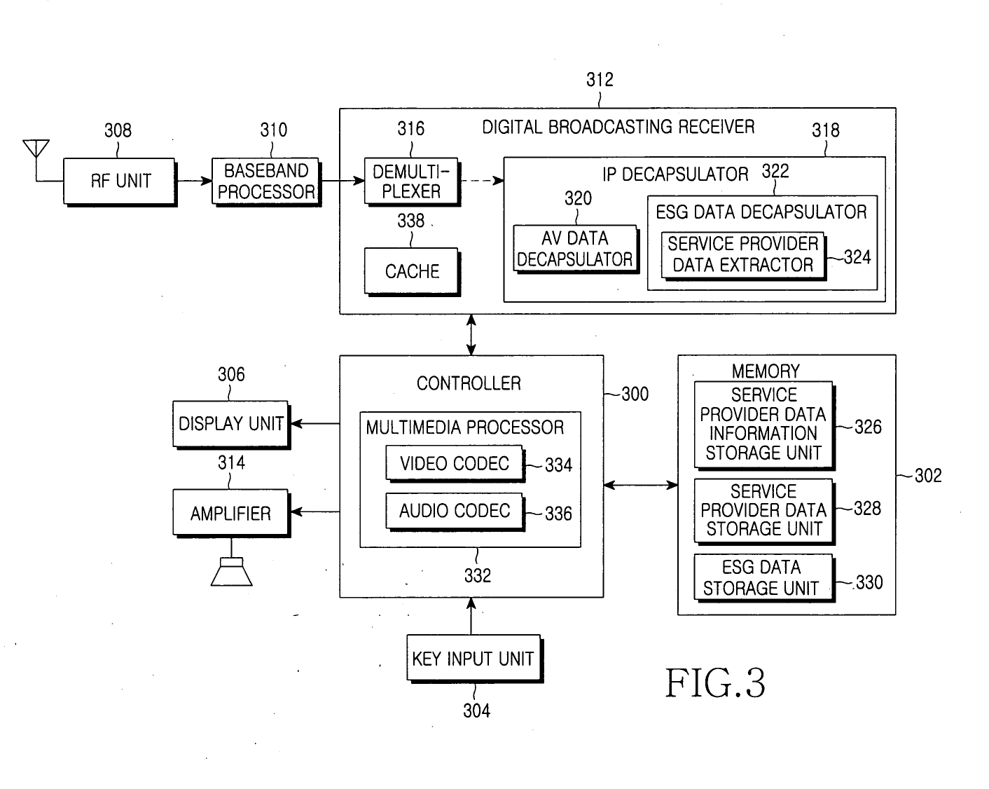

Referring to FIG. 3, in the digital broadcasting receiving terminal, a memory unit 302, a key input unit 304, a display unit 306, an amplifier 314, a baseband processor 310, and a digital broadcasting receiver 312 connect to a controller 300. Controller 300 performs voice signal and data processing on the basis of a protocol for radio Internet access and digital broadcasting, and controls each part of the digital broadcasting receiving terminal. Controller 300 receives the ESG data, and the AV data depending on the channel selected by the user, from digital broadcasting receiver 312. Controller 300 decodes the received AV data into an audio signal or a video signal, using a video codec 334 and an audio codec 336, and outputs the decoded AV data to display unit 306 and amplifier 314. Controller 300 receives user's key input from key input unit 304, and sets a channel. Therefore, controller 300 controls the display unit 306 to provide image information in response to the user's key input.

Receiving the ESG data, controller 300 loads previously stored service provider data information, and checks if the service provider data is included in the ESG data. If so, controller 300 extracts and stores the service provider data. Controller 300 can output the stored service provider data in various methods depending on preset output setting. For example, where the user views the digital broadcasting executing a buffering operation for initiating the digital broadcasting or when having to immediately inform the user of information such as a quick report, controller 300 can output the service provider data in a pop-up window over a screen that outputs the digital broadcasting or the service provider data is inserted into the broadcasting screen.

Memory 302 connecting with controller 300 includes a region for storing service provider data information for extracting the service provider data from the ESG data. The service provider data information can be transmitted in various methods. For example, the service provider data information can be transmitted even in a wireless network that can connect using a mobile communication network, not in a broadcasting network. The service provider data information refers to proper information of the service provider data for extracting the service provider data from the ESG data. The service provider data information can be the packet ID of the service provider data, or the bit value for indicating the service provider data.

Memory 302 includes a region for storing the service provider data extracted from the ESG data, and a region for storing the ESG data from which the service provider data is extracted. The storage region of memory 302 for storing the service provider data information is named a service provider data information storage unit 326, and the region for storing the service provider data is named a service provider data storage unit 328, and the region for storing the ESG data is named an ESG data storage unit 330.

Memory 302 is comprised of a read only memory (ROM), a Flash Memory, a Random Access Memory (RAM). Among them, the ROM stores a program for the processing and control of the controller 300, and a variety of reference data. The RAM provides a working memory of the controller 300, and the flash memory provides a region for storing a variety of updateable keeping data.

Key input unit 304 includes a variety of keys including numeric keys as above, and provides key input from the user to controller 300. A Radio Frequency (RF) unit 308 and baseband processor 310 receives the digital broadcasting data of the channel depending on user's selection. Baseband processor 310, which is a baseband analog ASIC (BBA) providing an interface between controller 300 and RF unit 308, converts an analog intermediate frequency (IF) signal received from RF unit 308 into a digital baseband signal, and applies the converted signal to controller 300. Baseband processor 310 sets the channel selected by the user, and outputs the digital broadcasting data received over the channel, to the digital broadcasting receiver 312. The display unit 306 and the amplifier 314 connect with controller 300, and outputs the video signal and the audio signal received from controller 300 under the control of controller 300.

According to the present invention, digital broadcasting receiver 312 includes a demultiplexer 316 for demultiplexing the digital broadcasting data received from baseband processor 310, into the AV data and the ESG data, and an IP decapsulator 318 for decapsulating the demultiplexed data. According to the present invention, IP decapsulator 318 includes an AV data decapsulator 320 for decapsulating the AV data received from demultiplexer 316, and an ESG data decapsulator 322 for decapsulating the ESG data received from demultiplexer 316. ESG data decapsulator 322 further includes a service provider data extractor 324 for receiving the service provider data information from controller 300, and extracting the service provider data from the ESG data using the received service provider data information. In case where digital broadcasting receiver 312 further includes a cache 338, it can check if the service provider data extracted from the ESG data is previously stored, and extract only the service provider data not previously stored, thereby increasing an efficiency of storage.

Accordingly, the digital broadcasting receiving terminal can extract the service provider data included in the ESG data. The digital broadcasting receiving terminal can output the extracted service provider data depending on the preset output setting. Thus, in the present invention, it is possible for the service provider to transmit data to be transmitted to the users, without going to the contents provider.

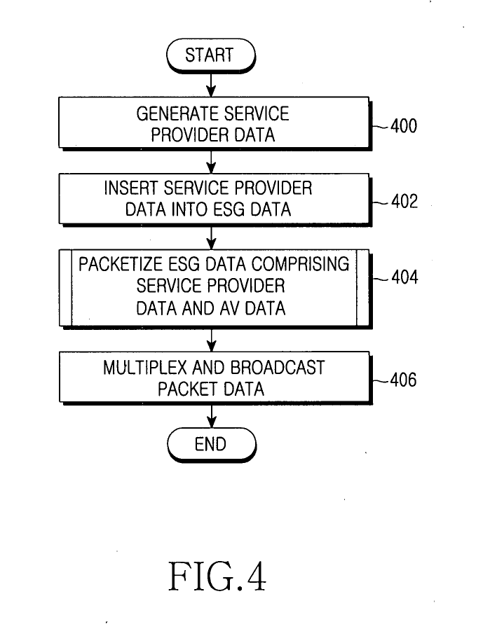

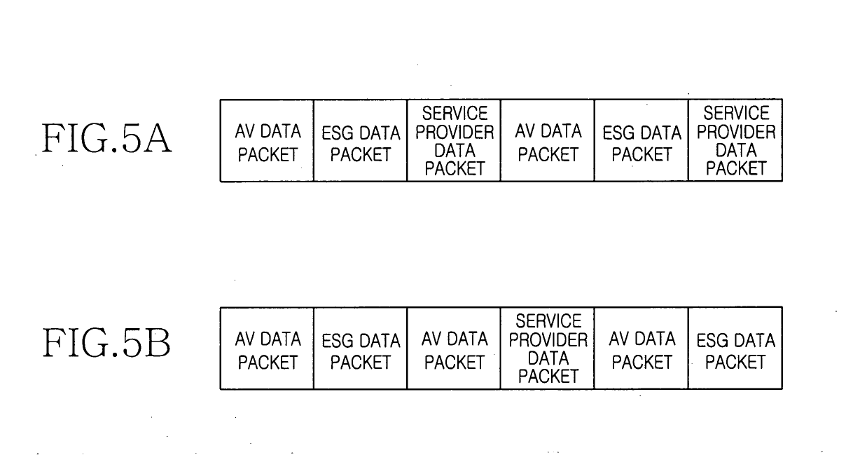

FIG. 4 is a flowchart showing a process of broadcasting the service provider data in the digital broadcasting station of the digital broadcasting system according to the present invention. FIG. 4 is based on the assumption that the digital broadcasting receiving terminal employs the method for extracting the service provider data from the ESG data using the packet ID. FIG. 5 shows an example of the service provider data inserted in the digital broadcasting station according to the present invention.

Referring to FIG. 4, in the digital broadcasting station of the digital broadcasting system according to the present invention, broadcasting unit 202 proceeds with Step 400 and generates the service provider data under the control of the service provider. The service provider data refers to data that the service provider intends to transmit to the users. The service provider data can be advertisement information of the service provider, or an urgent message that the service provider intends to urgently transmit to the user. The service provider data can be generated in various data formats, that is, in sound data format such as MP3 or moving picture data format such as MPEG4, and in a text data format such as TXT or still image data format such as JPEG

Upon the receipt of the AV data and the ESG data from contents providing unit 200, broadcasting unit 202 proceeds with Step 402 and inserts the generated service provider data into the ESG data. The service provider data can be inserted into the ESG data in various formats. FIG. 5 shows the example of the service provider data inserted into the ESG data.

Referring to FIG. 5, FIG. 5A shows an example in which the service provider data and the ESG data of a predetermined size are bundled and output to IP decapsulator 208, inserted and packetized between the AV data by a predetermined interval. FIG. 5B shows an example in which the service provider data and the ESG data of a predetermined size are alternately output to IP decapsulator 208, inserted and packetized between the AV data by a predetermined interval. In the example of FIG. 5A, the number of packets of the AV data transmitted during the same time period is less than that of FIG. 5B. Accordingly, depending on the state of transfer line or the transfer rate of data, the service provider can select any one of those various transmission methods, and additionally transmit the service provider data as long as smoothly as the AV data.

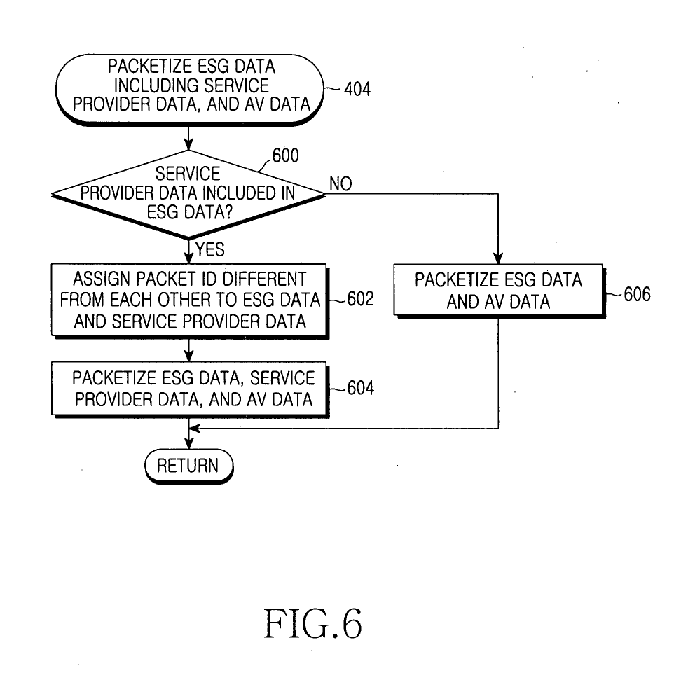

Broadcasting unit 202 proceeds with Step 404, and packetizes the ESG data including the service provider data and the AV data to which the respective packet ID are assigned. In Step 404, broadcasting unit 202 packetizes the service provider data and the ESG data to which the packet ID different from each other are assigned. However, the packet ID assigned to the service provider data is not beyond the packet ID range of the channel over which the ESG data is transmitted. For example, when it is assumed that the packet ID range of the channel for transmitting the ESG data has an identifyer of 100100 to 100200, and the packet ID of the ESG data has an identifier of 100150, the packet ID of the service provider data can have the identifyer of 100100 to 100200, and be set by an identifyer different from the value of 100150. In this case, broadcasting unit 202 transmits the service provider data over the same channel as the ESG data, but the digital broadcasting receiving terminal can extract the service provider data from data received over the ESG data channel using the packet ID. The operation of Step 404 will be described in detail with reference to FIG. 6 below.

Broadcasting unit 202 proceeds with Step 406, multiplexes and transmits the packet data packetized in Step 404. Thus, the user's digital broadcasting receiving terminal receives the multiplexed packet data over the channel for transmitting the digital broadcasting data, demultiplexes and decapsulates the received packet data so that the user can view his/her selecting digital broadcasting.

Of course, the digital broadcasting system can also use the bit value for indicating the service provider data, instead of the method for extracting the service provider data from the ESG data by the digital broadcasting receiving terminal, using the packet ID. Step 402 can also include the bit value in the service provider data. In this case, of course Step 404 can omit the process of assigning the packet ID different from each other to the service provider data and the ESG data.

Referring to FIG. 6, upon receipt of the ESG data including the service provider data in Step 404, broadcasting unit 202 of the digital broadcasting station proceeds with Step 600, and checks whether or not the service provider data is included in the received ESG data. When the check result of Step 600 is that the service provider data is not included in the ESG data, broadcasting unit 202 proceeds with Step 606, and packetizes the ESG data and the AV data. Broadcasting unit 202 proceeds with Step 406, multiplexes and broadcasts the packetized data.

When the check result of Step 600 is that the service provider data is included in the received ESG data, broadcasting unit 202 proceeds with Step 602, and assigns the packet ID different from each other to the ESG data and the service provider data. As described above, the packet ID assigned to the service provider data is included in the packet ID range of the channel for transmitting the ESG data, and is assigned a value different from that of the packet ID of the ESG data.

Broadcasting unit 202 proceeds with Step 604, and packetizes the ESG data, the service provider data, and the AV data. Broadcasting unit 202 proceeds with Step 406, multiplexes and transmits the packetized ESG data, service provider data, and AV data.

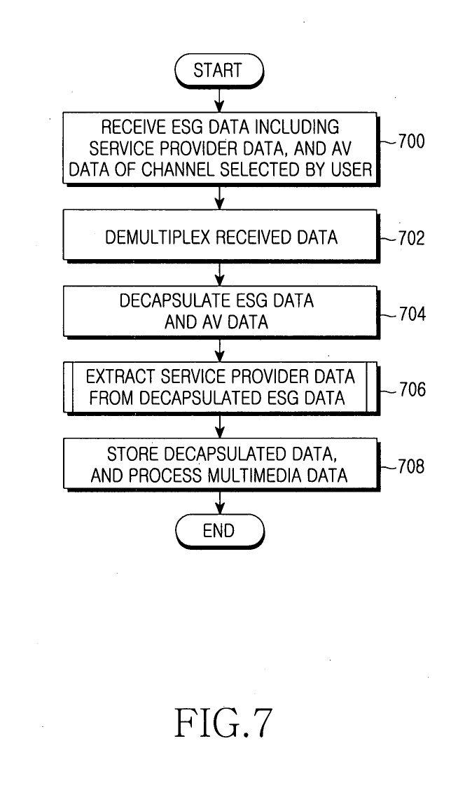

Referring to FIG. 7, controller 300 of the digital broadcasting receiving terminal proceeds with Step 700, and receives the ESG data including the service provider data, and the AV data of the channel selected by the user. Controller 300 proceeds with Step 702, and demultiplexes the received data. Controller 300 proceeds with Step 704, and decapsulates the received ESG data and AV data. Controller 300 proceeds with Step 706, and extracts the service provider data from the decapsulated ESG data.

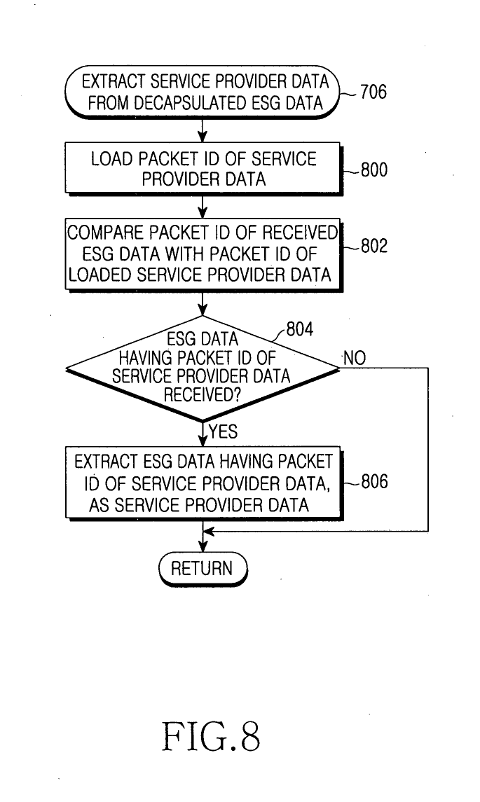

In Step 706, the service provider data can be extracted in various methods as above. In other words, for example, broadcasting unit 202 can set the packet ID different from that of the ESG data, to the service provider data, and extract the service provider data depending on the packet ID. Alternatively, broadcasting unit 202 can also extract the service provider data from the ESG data, using the bit value for indicating the service provider data. An operation of controller 300 of the digital broadcasting receiving terminal when the digital broadcasting receiving terminal extracts the service provider data from the ESG data using the packet ID will be described with reference to FIG. 8 below.

If the service provider data is extracted from the decapsulated ESG data in Step 706, controller 300 proceeds with Step 708, and decodes the AV data among the currently decapsulated data using multimedia processor 332, and then outputs the decoded AV data using display unit 306 and amplifier 314, and stores the ESG data and the service provider data in ESG data storage unit 330 and service provider data storage unit 328, respectively.

The stored service provider data can be output according to the preset output setting. For example, when the digital broadcasting receiving terminal is in a buffering state for initiating the digital broadcasting, the service provider data can be output in still image, background music, simple advertisement video, and text formats. Alternatively, the service provider data can be also inserted into the broadcasting screen of the digital broadcasting in the pop-up window type. Besides this, in case where there is a message content, such as an urgent notification for checking communication equipment that the service provider should urgently notify the user, if the service provider displays the urgent message in generation of the service provider data, the digital broadcasting receiving terminal receiving the urgent message can also preferentially output the received urgent message, irrespective of the digital broadcasting. Thus, in the present invention, the message that the service provider intends to transmit can be freely transmitted to the user.

Referring to FIG. 8, in the digital broadcasting receiving terminal, upon the completion of decapsulation of the ESG data and the AV data, controller 300 proceeds with Step 800, and loads information on the packet ID of the service provider data from the service provider data information storage unit 326. Controller 300 proceeds with Step 802, and compares the packet ID based on the loaded service provider data information with each of the packet ID of the currently received ESG data.

Controller 300 proceeds with Step 804, and checks whether or not it receives the ESG data having the packet ID that corresponds to the packet ID of the service provider data. Not receiving the ESG data having the packet ID corresponding to the packet ID of the service provider data, controller 300 determines that the ESG data does not include the service provider data, and proceeds with Step 708 of FIG. 7 and processes the decapsulated AV data and ESG data.

However, when the check result of Step 804 is that controller 300 receives the ESG data having the packet ID that corresponds to the packet ID of the service provider data, controller 300 proceeds with Step 806, recognizes and extracts the ESG data having the packet ID of the service provider data, as the service provider data. Controller 300 stores the extracted data in the service provider data storage unit 328. Controller 300 proceeds with Step 708 of FIG. 7, and processes the decapsulated AV data and ESG data. Thus, the present invention can distinguish the service provider data transmitted over the channel for transmitting the ESG data, from the ESG data, using the assigned packet ID different from that of the ESG data, and extract only the service provider data.

Accordingly, in the present invention, the service provider can broadcast the information that the service provider intends to transmit to the users, even not going through the contents provider.

While the invention has been shown and described with reference to certain preferred embodiments thereof, it will be understood by those skilled in the art that various changes in form and details may be made therein without departing from the spirit and scope of the invention as further defined by the appended claims. Specifically, among a plurality of digital broadcasting methods, the DVB-H method is described as one example of the present invention, but it is of course that the present invention is applicable to other digital broadcasting methods. In other words, in a DMB method also, the service provider data can be transmitted to the users over the channel for transmitting the EPG data, which is program guide information, and the service provider data can be extracted from the data transmitted over the EPG channel and be stored, and can be output according to the preset output setting.

What is claimed is:

1. A digital broadcasting system for broadcasting service provider data, the system comprising:
a broadcasting station for inserting the service provider data, which is generated by a service provider; and
a digital broadcasting receiving terminal for receiving the multimedia data from the broadcasting station.

2. The system of claim 1, wherein the service provider provides a service of digital broadcasting contents to users using a specific leased line communication frequency, into program guide information of various digital broadcasting contents, and broadcasting the service provider data, together with multimedia data based on the various digital broadcasting contents.

3. The system of claim 1, wherein the digital broadcasting receiving terminal decodes and outputs the received multimedia data, and receives the program guide information comprising the service provider data from the broadcasting station, extracts the service provider data, and outputs the extracted service provider data according to preset output setting.

4. The system of claim 2, wherein the broadcasting station comprises:
a contents providing unit for providing the broadcasting contents; and
a broadcasting unit comprising:
a service provider data generator for generating the service provider data;
a transfer server for receiving the program guide information from the contents providing unit, performing data integrity processing of the program guide information on the basis of a protocol for enhancing data integrity, and inserting the service provider data into the program guide information;
a packetizer for packetizing the program guide information comprising the service provider data, and the multimedia data; and
a multiplexer for multiplexing and broadcasting the packetized data over each channel.

5. The system of claim 4, wherein, the packetizer assigns the service provider data a packet ID (identification), which is comprised in a packet ID range of a channel for transmitting the program guide information but is different from a packet ID assigned to the program guide information if the program guide information comprises the service provider data.

6. The system of claim 5, wherein the digital broadcasting receiving terminal comprises:
a memory for storing the service provider data packet ID for distinguishing the service provider data from the program guide information;
a digital broadcasting receiver for receiving and restoring the packetized multimedia data, extracting the service provider data from the program guide information using the service provider data packet ID, and output the extracted service provider data together with the multimedia data and the program guide information; and
a controller for receiving the service provider data, and outputting the received service provider data depending on the preset output setting.

7. The system of claim 6, wherein the output setting is made such that the service provider data is output at the time of a buffering operation for initiating digital broadcasting, or in a pop-up window type over a screen for outputting the digital broadcasting thereon or a type where the service provider data is inserted into the broadcasting screen, depending on a kind of the service provider data if the user selects digital broadcasting view.

8. The system of claim 6, wherein the digital broadcasting receiver comprises a cache for temporarily storing the service provider data before it is output to the controller.

9. The system of claim 8, wherein the controller checks if the service provider data extracted from the program guide information is previously stored, and, if not, stores the service provider data not previously stored.

10. The system of claim 5, wherein the transfer server inserts service provider data indication information, which are spare bits for indicating the service provider data, into the service provider data.

11. The system of claim 10, wherein the digital broadcasting receiving terminal comprises:
a memory for storing the service provider data packet ID for distinguishing the service provider data from the program guide information;
a digital broadcasting receiver for receiving and restoring the packetized multimedia data, extracting the service provider data from the program guide information using the service provider data packet ID, and outputting the extracted service provider data together with the multimedia data and the program guide information; and
a controller for receiving the service provider data, and outputting the received service provider data depending on the preset output setting.

12. The system of claim 11, wherein the output setting is made such that the service provider data is output at the time of a buffering operation for initiating digital broadcasting, or in a pop-up window type over a screen for outputting the digital broadcasting thereon or a type where the service provider data is inserted into the broadcasting screen, depending on a kind of the service provider data if the user selects digital broadcasting view.

13. The system of claim 11, wherein the digital broadcasting receiver comprises a cache for temporarily storing the service provider data before it is output to the controller.

14. The system of claim 13, wherein the controller checks if the service provider data extracted from the program guide information is previously stored, and, if not, stores the service provider data not previously stored.

15. The system of claim 1, wherein the digital broadcasting system is based on a digital video broadcasting-hand held (DVB-H) method.

16. The system of claim 15, wherein the program guide information is an electronic program guide (EPG) data.

17. A method for broadcasting service provider data by a broadcasting station, in a digital broadcasting system having the broadcasting station for broadcasting various digital broadcasting contents and the service provider data and a digital broadcasting receiving terminal for receiving the digital broadcasting contents and the service provider data, the method comprising the steps of:
generating the service provider data by the broadcasting station;
inserting, by the broadcasting station, the service provider data into program guide information of the broadcasting contents that are provided from a contents providing unit;
packetizing, by the broadcasting station, the program guide information comprising the service provider data, and multimedia data based on the various broadcasting contents;
multiplexing and broadcasting the packetized packet data by the broadcasting station;
receiving and demultiplexing the multiplexed packet data by the digital broadcasting receiving terminal;
extracting, by the digital broadcasting receiving terminal, the service provider data from the packet data associated with the program guide information, among the demultiplexed packet data;
restoring, by the digital broadcasting receiving terminal, the extracted service provider data, the multimedia data, and the program guide information, to original data; and
outputting the service provider data depending on preset output setting by the digital broadcasting receiving terminal.

18. The method of claim 17, wherein, in the inserting step, the service provider data and the program guide information of a predetermined size are bundled and inserted between the multimedia data by a predetermined interval, or the service provider data and the program guide information of a predetermined size are alternatively inserted between the multimedia data by a predetermined interval.

19. The method of claim 17, wherein the packetizing step comprises:
checking by the broadcasting station whether or not the program guide information comprises the service provider data;
when it is checked to comprise the service provider data, assigning, by the broadcasting station, packet ID different from each other to the program guide information and the service provider data; and
packetizing the program guide information, the service provider data, and the multimedia data by the broadcasting station.

20. The method of claim 19, wherein the extracting step comprises:
loading, by the digital broadcasting receiving terminal, a packet ID of previously stored service provider data;
comparing, by the digital broadcasting receiving terminal, a packet ID of packet data associated with the program guide information, with a packet ID of the service provider data; and
when the packet ID comparison result is that the packet ID of the packet data corresponds to the packet ID of the service provider data, extracting the packet data as the service provider data by the digital broadcasting receiving terminal.

21. The method of claim 17, wherein the inserting step comprises:
inserting, by the broadcasting station, the service provider data into the program guide information of the broadcasting contents that are provided from the contents providing unit; and
inserting, by the broadcasting station, service provider data indication information for indicating the service provider data, into the service provider data.

22. The method of claim 21, wherein the extracting step comprises:
loading previously stored service provider data indication information by the digital broadcasting receiving terminal;
checking by the digital broadcasting receiving terminal whether or not there is the packet data having the service provider data indication information inserted, among the packet data associated with the program guide information; and
when it is checked that there is the packet data having the service provider data indication information, extracting the packet data as the service provider data by the digital broadcasting receiving terminal.

23. The method of claim 17, wherein, in the outputting step, the digital broadcasting receiving terminal outputs the service provider data when its current operation is a buffering operation for initiating digital broadcasting.

24. The method of claim 17, wherein, in the outputting step, the digital broadcasting receiving terminal outputs the service provider data in a pop-up window type over a screen for outputting the digital broadcasting thereon or a type where the service provider data is inserted into the broadcasting screen, depending on a kind of the service provider data.

25. The method of claim 17, wherein the digital broadcasting receiving terminal comprises a cache for temporarily storing the service provider data before it is outputted to the controller.

26. The method of claim 17, further comprising:
checking by the digital broadcasting receiving terminal if the service provider data extracted from the program guide information is previously stored, and, if not, stores the service provider data not previously stored; and
when the storage check result is to receive the service provider data previously stored, storing the received service provider data by the digital broadcasting receiving terminal.

27. The method of claim 17, based on a digital video broadcasting-handl held (DVB-H) method.

28. The method of claim 17, wherein the program guide information is an electronic program guide (EPG) data.
